(19) United States
(12) Patent Application Publication
(10) Pub. No.: US 2025/0256252 A1
(43) Pub. Date: Aug. 14, 2025

(54) AUTOMATED SYSTEM FOR SCREENING AND OPTIMIZING NANOPARTICLE FORMULATIONS

(71) Applicant: Wyatt Technology, LLC, Goleta, CA (US)

(72) Inventor: Daniel I. Some, Atlit (IL)

(21) Appl. No.: 19/048,205

(22) Filed: Feb. 7, 2025

Related U.S. Application Data
(60) Provisional application No. 63/551,481, filed on Feb. 8, 2024.

(51) Int. Cl. B01F 33/30; B01F 35/22; B01F 35/71; G01N 15/1409; G01N 35/00; G01N 35/10

(52) U.S. Cl. CPC B01F 33/304; B01F 35/2205; B01F 35/7176; G01N 15/1409; G01N 35/00584; G01N 35/10; G01N 2035/00891

(57) ABSTRACT

An apparatus, system, and method comprise receiving, by a computer system, a series of mixing parameters; transmitting, by the computer system, a series of commands corresponding to a series of mixing parameters to a microfluidic mixing system to mix a series of at least two solutions, wherein one of the solutions includes lipids in an organic solvent and the other solution includes ribonucleic acid (RNA) in an aqueous solvent; and generating in response a plurality of formulations of lipid nanoparticles (LNPs) encapsulating the RNA according to the series of mixing parameters.

### PRIORITY

This application claims priority to U.S. provisional patent application No. 63/551,481 filed Feb. 8, 2024 and titled “AUTOMATED SYSTEM FOR SCREENING AND OPTIMIZING NANOPARTICLE FORMULATIONS,” the entirety of which is incorporated by reference herein.

### BACKGROUND

The present disclosure relates to adaptive techniques for developing microfluidic formulations, and more specifically, the development of a nanomedicine comprising a carrier nanoparticle encapsulating a molecular payload, such as a ribonucleic acid (RNA) in lipid nanoparticles (LNPs).

LNP-RNA nanoparticles are expected to become one of the most popular modalities for vaccines and gene therapy. LNP formulations are formulated by microfluidic mixing to encapsulate active pharmaceutical ingredients (APIs). Multiple conditions such as flow rates, solution properties, lipid mixtures, etc. must be tested and screened to produce the optimal LNP-RNA in terms of size, encapsulation efficiency, etc. Similar tests must be run to optimize conditions for formulating other types of nanomedicines that are produced by microfluidic mixing.

Also, in the course of developing microfluidic formulations of RNA in lipid nanoparticles, many combinations of total flow rate, flow ratio, RNA buffer, and lipid composition must be tested. While instruments are beginning to emerge that automate such screening tasks, they do not incorporate inline analytics for immediate feedback.

### SUMMARY

In one aspect, a computer-implemented method comprises receiving, by a computer system, a series of mixing parameters; transmitting, by the computer system, a series of commands corresponding to a series of mixing parameters to a microfluidic mixing system to mix a series of at least two solutions, wherein one of the solutions includes lipids in an organic solvent and the other solution includes ribonucleic acid (RNA) in an aqueous solvent; and generating in response a plurality of formulations of lipid nanoparticles (LNPs) encapsulating the RNA according to the series of mixing parameters.

In another aspect, a computer-implemented method comprises receiving, by a computer system, a series of mixing parameters; transmitting, by the computer system, a series of commands corresponding to series of mixing parameters to a microfluidic mixer to mix a series of at least two solutions, wherein one of the solutions includes encapsulating molecules in an organic solvent and the other solution includes payload molecules in an aqueous solvent, resulting in formulations of nano-capsules encapsulating the payload molecules according to the series of mixing parameters; and transmitting, by the computer system, a command to direct the series of formulations to the sample collector such that each formulation is dispensed to a distinct receptacle corresponding to the corresponding mixing parameters.

In another aspect, an apparatus comprises a microfluidic mixer that mixes a series of at least two solutions, wherein one of the solutions includes encapsulating molecules in an organic solvent and the other solution includes payload molecules in an aqueous solvent; and a sample collector to dispense each formulation to a distinct receptacle corresponding to the corresponding mixing parameters and translate a receptacle to receive dispensed fluid from the mixer.

### BRIEF DESCRIPTION OF THE DRAWINGS

FIG. 1 depicts a block diagram of a system for processing microfluidic formulations of RNA in lipid nanoparticles at which some embodiments of the present inventive concept can be practiced.

FIG. 2 depicts a block diagram of a system for processing microfluidic formulations of RNA in lipid nanoparticles at which other embodiments of the present inventive concept can be practiced.

FIG. 3 depicts a flowchart of a method, in accordance with an embodiment.

FIG. 4 depicts a flowchart of a method, in accordance with another embodiment.

FIG. 5 depicts a computer procedure, in accordance with another embodiment.

FIG. 6 depicts an example of a system configured for condition screening with inline dilution, in accordance with an embodiment.

FIG. 7 depicts an example of a system configured for condition screening with buffer variation, in accordance with an embodiment.

FIG. 8 depicts an example of a system comprising a microfluidic mixing system and Multi-Angle Light Scattering (MALS) detection instrument configured for generating large volumes, in accordance with an embodiment.

FIG. 9 depicts an example of a system configured for condition screening of small volumes, in accordance with an embodiment.

FIG. 10 depicts an example of a system configured for condition and lipid mixture screening, in accordance with an embodiment.

FIG. 11 depicts an example of a system configured for condition screening with inline buffer exchange, in accordance with an embodiment.

FIG. 12 depicts a display output, in accordance with an embodiment.

FIG. 13 depicts a computer system, in accordance with an exemplary embodiment.

### DETAILED DESCRIPTION

In brief overview, embodiments of the present disclosure describe an apparatus and method that provide a comprehensive solution to fully automated screening integrated with real-time or high-throughput analysis of the resulting nanoparticles. Such a solution may include a fully automated microfluidic mixing system combined with sample collector such as an HPLC fraction collector or the like, and which may optionally integrate with other apparatuses that can, for example, include instruments that measure dynamic and static light scattering (MALS/DLS) in situ in standard microwell plates and/or perform inline analytic operations, but not limited thereto.

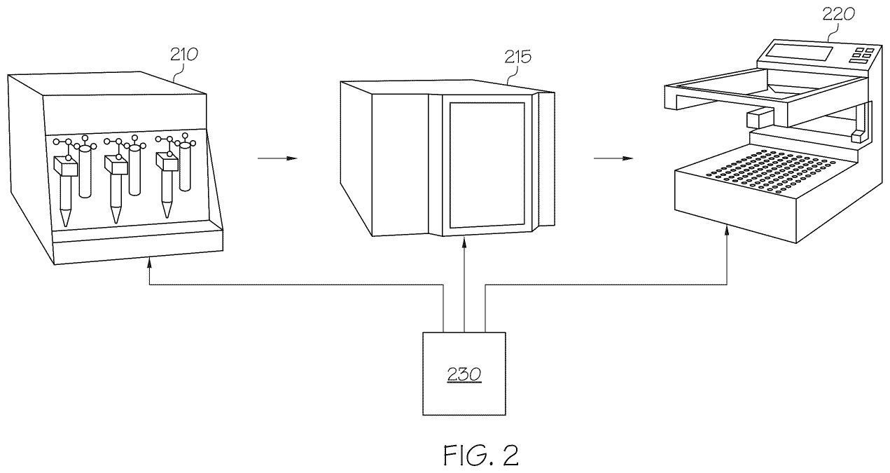

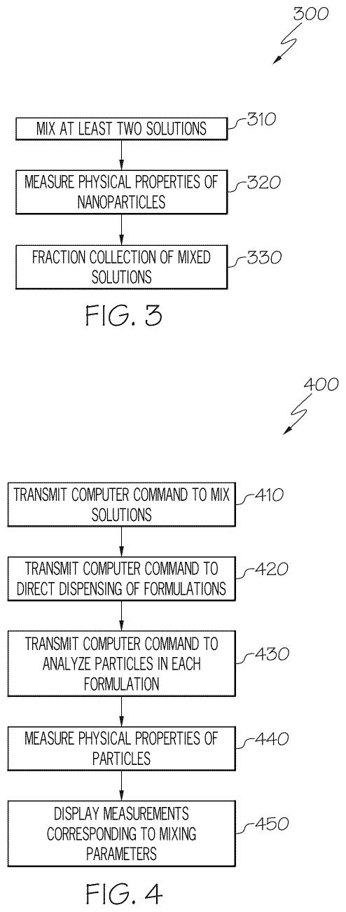

During operation, the mixing system can be programmed by a special-purpose computer to mix up to three, or more, different solutions at preselected conditions in order to produce the specified volume of LNPs. Each sample can be collected by the sample collector into a vial or a well in a well plate. In some embodiments, for example, shown in FIGS. 2 and 3, a particle analyzer or the like can be positioned between the mixing system and the sample collector for performing in-line analytics, for example, measurements of particle size and concentration during a stop-flow period following a syringe dispense operation. Samples from the sample collector can be tested following a ripening period by a plate reader, or a combination of an autosampler, pump, and particle analysis system for post-formulation analytics.

Accordingly, embodiments of the present inventive concept include a fully automated microfluidic mixing system capable of formulation screening of many conditions with no manual intervention, combined with inline analytics (MALS/DLS) and a chromatography fraction collector to collectively provide a versatile workflow for screening LNP-RNA formulations resulting in high productivity as compared to conventional manual-intensive systems. This is beneficial for accommodating the rising popularity of LNP-RNA nanoparticles as modalities for vaccines and gene therapy, as well as other nanomedicines produced by similar mixing processes. Current formulation screening systems, on the other hand, require significant manual labor, for example, exchanging vials, filling and replacing syringes, offline analysis and so on, resulting in low productivity.

### Definitions

### Particle

A particle may be a constituent of a liquid sample aliquot. Such particles may be molecules of varying types and sizes, nanoparticles, virus like particles, liposomes, emulsions, bacteria, and colloids. These particles may range in size from sub-nanometer to microns.

### Analysis of Macromolecular or Particle Species in Solution

The analysis of macromolecular or particle species in solution may be achieved by preparing a sample in an appropriate solvent and then injecting an aliquot thereof into an analytical system. In some cases, the analysis may take place “in batch”, i.e. without separation. In other cases, the analytical system may comprise a sample separation system such as a liquid chromatography (LC) column or field flow fractionation (FFF) channel where the different species of particles contained within the sample are separated into their various constituencies. Once separated, generally based on size, mass, or column affinity, the samples may be subjected to analysis. Analysis in a batch or separation method may be accomplished by measuring light scattering, refractive index, ultraviolet absorption, electrophoretic mobility, and/or viscometrical responses.

Light scattering (LS) represents a family of non-invasive techniques for characterizing macromolecules and sub-micron particles in solution or suspension. The types of light scattering detection frequently used for the characterization of nanoparticles such as nanomedicines, or more specifically, nanocapsules, are multi-angle static light scattering (MALS), dynamic light scattering (DLS) and electrophoretic light scattering (ELS).

MALS is a LS technique used to determine molar mass, particle size and particle concentration. MALS involves illumination, by means of a laser beam, of a volume containing solution or suspension of the nanoparticles to be characterized. Light scattered by the nanoparticles is detected simultaneously by multiple photodetectors, each positioned at a different scattering angle with respect to the laser beam. As is known to those skilled in the art, the signals representing the time-averaged scattering intensity as a function of angle are analyzed to determine physio-chemical properties such as molar mass, particle size and particle concentration. Different models may be applied to the angle-dependent intensities so as to interpret the results in terms of spherical radius, rod length, random coil radius and root-mean-square radius.

DLS, also known as quasi-elastic light scattering (QELS) and photon correlation spectroscopy (PCS), is an LS technique used to determine particle hydrodynamic size, polydispersity and—in combination with static light scattering—particle concentration. Similar to MALS, a volume containing a solution or suspension of macromolecules or nanoparticles is illuminated by means of a laser beam. In a DLS measurement, time-dependent fluctuations in the scattered light intensity are measured using a fast photodetector, typically positioned at a single scattering angle with respect to the laser beam, though methods of utilizing multiple scattering angles are known. As is known to those skilled in the art, DLS measurements determine the diffusion coefficient of the molecules or particles, which can in turn be used to calculate their hydrodynamic radius and polydispersity. DLS measurements may be combined with static light scattering measurements to determine particle concentration and, in the case of multi-modal samples (i.e. samples containing at least two population of sufficiently distinct size), the particle concentrations of each of more than one population.

### Electrophoretic Light Scattering

Electrophoretic light scattering (ELS) is a LS technique used to measure the electrophoretic mobility and zeta potential of nanoparticles in solution or suspension. A laser beam is split into two, with one beam (sample beam) routed through a cell containing the sample to be measured and the other beam (reference beam) routed around the cell to the photodetector. A portion of the light scattered by the sample arrives at a photodetector where it interferes coherently with the reference beam.

An ELS measurement takes place in a cell containing two electrodes. An electrical field is applied to the electrodes, and particles or molecules that have a net charge, or more strictly a net zeta potential, will migrate towards the oppositely charged electrode with a velocity. As is known to those skilled in the art, the particle velocity and direction of motion are determined by applying a periodic phase shift to the reference beam and measuring the frequency shift of the light scattered by the sample. The ratio of this velocity to the applied electric field is the electrophoretic mobility, which can be expressed as a zeta potential by applying theoretical models. The direction of motion relative to the direction of the applied field is used to determine the sign of the electrophoretic mobility, i.e. positive or negative, which corresponds to the polarity of the charge on the particle.

### Overview

It is well-known that nanoparticles can be produced by microfluidics in a reproducible and accurate manner. The manufacturing technique can be chosen according to the physical properties of the particle used to encapsulate and the encapsulated agent. However, there is a need to provide a comprehensive system to fully automate screening tasks in the course of developing microfluidic formulations including the particle used to encapsulate, i.e., carrier nanoparticle and the agent, i.e., payload, or more specifically, nanocapsules comprising a protective shell with a core comprising mRNA or other bioactive compound.

### FIGURES

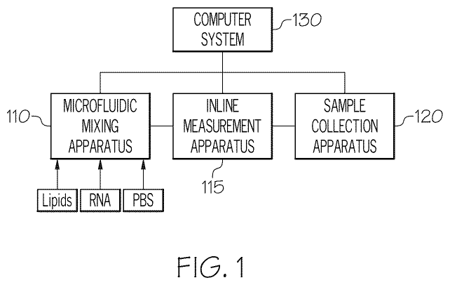

FIG. 1 depicts a block diagram of a system 10 at which embodiments of the present inventive concept can be practiced. The system 10 is constructed and arranged to process microfluidic formulations of RNA in lipid nanoparticles, and in doing so may include a microfluidic mixing apparatus 110, an inline measurement apparatus 115, a sample collection apparatus 120, and a special-purpose computer 130 for controlling the mixing operations performed by the microfluidic mixing apparatus 110 and the collection operations of the sample collection apparatus 120.

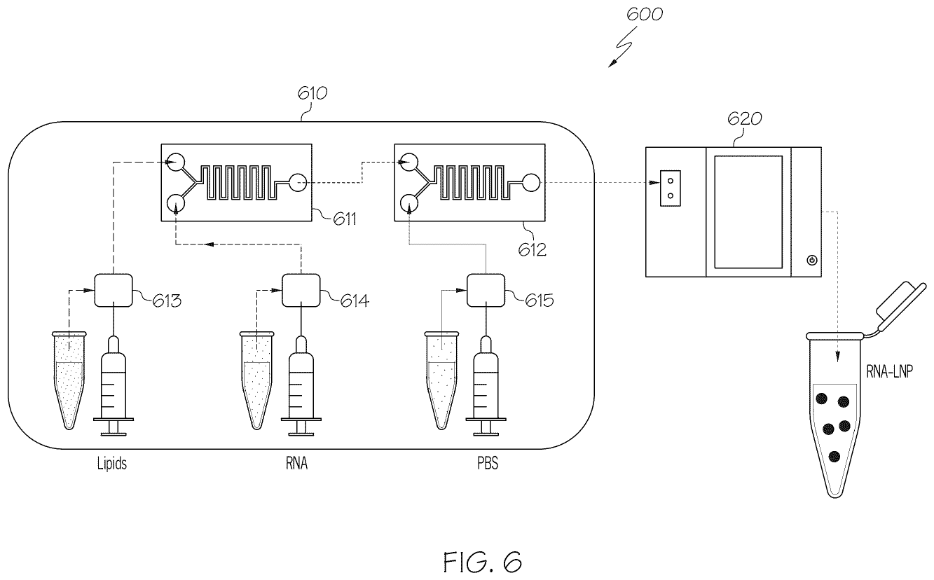

In some embodiments, the mixing apparatus 110 is constructed and arranged to operate on two or more fluid volumes for performing chemical or biochemical reactions to achieve high and repeatable yields. In some embodiments, the mixing apparatus 110 comprises a first input port for receiving a first solution comprising lipids or other particle-forming molecules dissolved in an organic solvent and a second input port for receiving a second solution mRNA or other oligonucleotides or drug molecules in an aqueous solvent. A microfluidic mixing operation is performed on the two solutions (e.g., shown in FIGS. 6-11) whereby the lipids precipitate and form nanoparticles that encapsulate the mNRA. In some embodiments, the mixing apparatus 110 comprises a third input port for receiving a source of a diluent or buffer solution such as phosphate buffered saline (PBS), which can be mixed with the aqueous and organic solutions input by the first and second input ports, respectively. Accordingly, the mixing apparatus 110 can mix in some embodiments two solutions and in other embodiments three solutions. In other embodiments, the microfluidic mixing apparatus 110 includes at least one computer processor programmed to receive command instructions from the special-purpose computer 130 to mix the solutions provided by the input ports at selected conditions in order to produce the specified volume of LNPs. The mixing operation may result in electrostatic and hydrophobic/hydrophilic interactions that drive the coalescence of nanoparticles, or polymeric particles in the nanometer size range, which can be measured, analyzed, or otherwise processed by other instruments downstream from the mixer 110 as described below. Examples are provided in FIGS. 6-11 and the Appendix attached herewith. Also, shown and described with reference to FIGS. 6-11 are various embodiments of a microfluidic mixing system, which can be similar to or the same as a mixing apparatus of FIGS. 1-3. For example, in some embodiments, the microfluidic mixing apparatus 110 may be part of a system comprising at least two microfluidic pumps, such as syringe pumps that receive the contents of the inputs for filling and dispensing to provide a more accurate mixing ratios, or a continuous pump drawing from a reservoir, as well as at least one microfluidic mixer, e.g., including at least one microfluidic mixing chip, T-junction mixer, Y-junction mixer, and augmented T-junction mixer, but not limited thereto. The syringe pumps are constructed and arranged to provide accurate mixing ratios, and can be filled with and dispense one volume of solution at a time. In other embodiments, the pumps include a continuous pump drawing solution from a reservoir or the like. The continuous pumps can be selected from the group consisting of peristaltic pumps, pressure-driven pumps, piston pumps, and diaphragm pumps. The input ports can communicate with three computer-controlled syringe pumps together with associated degassers, filters, mixers and valves, such that the syringe pumps can provide a delivery to the sample collection apparatus 120 of a solution at a desired mixing ratio.

In the course of developing microfluidic formulations of nanoparticles encapsulating mRNA or the like, e.g., or other oligonucleotides or drug molecules, many combinations of total flow rate, flow ratio, RNA buffer and lipid composition may be tested. Accordingly, the mixing apparatus 110 can not only automate such screening tasks, but also integrate with the inline measurement apparatus 115 and sample collection apparatus 120 for generating an output for analytics, and in particular, provide a collective comprehensive solution to fully automate screening integrated with real-time or high-throughput analysis of the resulting nanoparticles. The inline measurement apparatus 115 between the mixing apparatus 110 and the sample collection apparatus 120 allows for immediate feedback on the success of forming nanoparticles of a desired size and/or other characteristics using the specific mixing conditions provided by the computer 130.

In some embodiments, as shown in FIG. 1, the sample collection apparatus 120 is constructed of receiving adapter racks and related collection vessels arranged to collect each sample output from the mixing apparatus 110, and direct the formulations to a distinct receptacle, e.g., a vial, well in a well plate, or other temporary storage vehicle according to a set of mixing parameters (described below). Said sample outputs consist of formulations of lipid nanoparticles (LNPs) encapsulating the RNA (LNP-RNA—LNP encapsulating RNA). In some embodiments, the sample collection apparatus 120 includes a chromatography fraction collector or the like, which may support racks, microplates, vials, tubes, or other collection vessels to allow samples to be collected in small, fixed volumes, or controlled by the computer 130 to capture the eluting fluid in tubes, vials, or the like. For example, a tray of tubes or plate containing samples may be manually or automatically loaded into the sample collection apparatus 120, which is controlled by the computer 130 to dispense each sample to a different tube or well. In some embodiments, after the abovementioned mixing, measuring, and collecting steps, samples from the sample collection apparatus 120 can optionally be tested using an autosampler, pump, plate reader, or other analysis device(s). For example, a light scattering measurement instrument (not shown) can be at the output of the sample collection apparatus 120 configured as a sample collector for forming automated measurements on the output of the sample collection apparatus 120. Samples from the sample collector can be tested following a ripening period by vials or the like by the light scattering measurement instrument using an autosampler and pump, but not limited thereto.

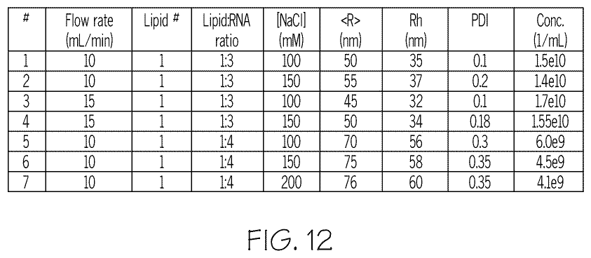

The special-purpose computer 130 stores and executes algorithms for controlling the microfluidic mixing system 110 and sample collection apparatus 120, for example, according to processes described in embodiments herein. For example, the computer 130 can control the pumps, injection devices, and processors of the mixing apparatus shown in FIGS. 6-11. The special-purpose computer 130 is configured to transmit a series of commands corresponding to a series of mixing parameters to the microfluidic mixing system 110 to mix a series of at least two solutions. The computer 130 may receive a series of predetermined mixing parameters, e.g., flow rate, total volume and relative amount of each solution programmed by a user or other computer into the computer 130, and generate a series of commands corresponding to a series of mixing parameters to the microfluidic mixing system 110 to mix a series of at least two solutions, where one solution includes lipids in an organic solvent and the other solution includes RNA in an aqueous solvent, resulting in formulations of lipid nanoparticles (LNPs) encapsulating the RNA according to the series of mixing parameters. In other embodiments, one of the solutions includes encapsulating molecules in an organic solvent and the other solution includes payload molecules in an aqueous solvent, resulting in formulations of nano-capsules encapsulating the payload molecules (e.g., LNP-RNA—LNP encapsulating RNA) according to the series of mixing parameters. In some embodiments, the computer 130 generates a command to direct the series of formulations to the sample collector 120 such that each formulation is dispensed to a distinct receptacle (vial/well in well plate) corresponding to the corresponding mixing parameters (translate a receptacle to receive dispensed fluid from the mixer 110). The computer 130 may include a database, or communicate with a database, to store measurements corresponding to the mixing parameters. The computer 130 may include a display, or communicate with a remote display, to display measurements corresponding to the mixing parameters, for example, shown in FIG. 12.

FIG. 2 depicts a block diagram of a system 20 for processing microfluidic formulations of RNA in lipid nanoparticles at which other embodiments of the present inventive concept can be practiced. The system 20 is constructed and arranged to process microfluidic formulations of RNA in lipid nanoparticles, and in doing so may include a microfluidic mixing apparatus 210, a light scattering instrument 215, a sample collection apparatus 220, and a special-purpose computer 230, which may be similar to those counterpart components described above with respect to FIG. 1. The microfluidic mixing apparatus 210 can, for example, consist of a Calypso™ composition-gradient system by Wyatt Technology that includes three computer-controlled syringe pumps with associated valves, sensors and microfluidic connections.

In some embodiments, the system 20 also includes an inline measurement apparatus, namely, a light scattering instrument 215 positioned between the microfluidic mixing apparatus 210 and the sample collection apparatus 220 for inline measurement and characterization of nanoparticles during a stop-flow period, following a mixing operation. The light scattering instrument 215 may be used to perform light scattering analysis or the like for the inline measurement of particles. In some embodiments, the light scattering instrument 215 can include a multiangle light scattering (MALS) instrument, for example, an ultraDAWN™ instrument by Wyatt Technology that is normally used to measure a molar mass, size and particle concentration in real-time in order to monitor product attributes inline or online with downstream purification and fill-finish processes. In other embodiments, the light scattering instrument 215 can include a DynaPro™ ZetaStar™ light scattering instrument by Wyatt Technology, which combines simultaneous DLS and electrophoretic mobility measurements to determine size, polydispersity, and zeta potential.

In some embodiments, the system 20 includes a DLS plate reader (not shown) such as a DynaPro™ Plate Reader for performing a post-formulation analytics operations on the output of the sample collection apparatus.

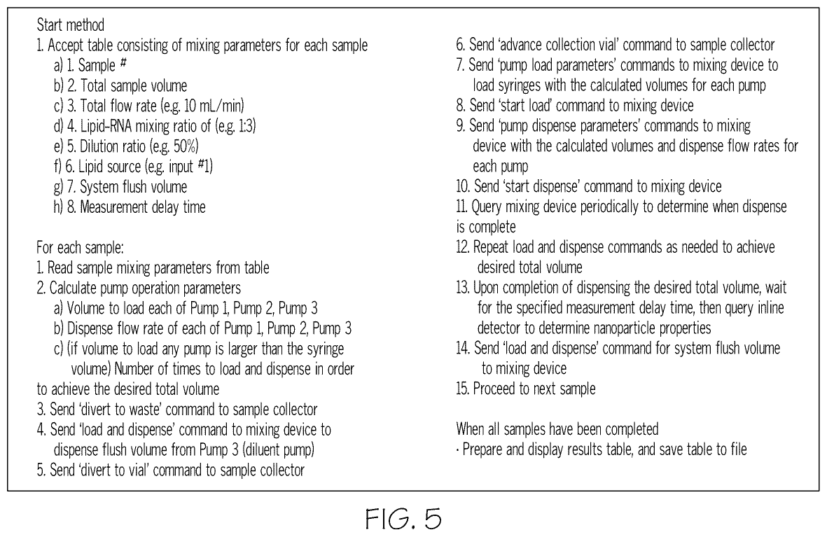

The special-purpose computer 230 includes one or more processors, data storage, and peripherals such as input/output devices to communicate electronically with the mixing apparatus 210, MALS instrument 215, sample collection apparatus 220, and/or DLS plate reader 225. Data exchanges may include the computer 230 generating commands for the mixing apparatus 210, sample collection apparatus 220, and light scattering instrument 215. In some embodiments, the computer 230 generates a series of commands corresponding to a series of mixing parameters to the microfluidic mixing apparatus 210 to mix a series of at least two solutions. In some embodiments, the computer 230 generates at least one command to direct the series of formulations to the sample collector 220 such that each formulation is dispensed to a distinct receptacle (vial/well in well plate) corresponding to the corresponding mixing parameters (translate a receptacle to receive dispensed fluid from the mixer). In some embodiments, the computer 230 generates at least one command to the particle analyzer 215 to analyze LNP-RNA particles in each formulation, resulting in measurements of physical properties of the LNP-RNA particles (e.g., particle size, concentration). In some embodiments, as shown in FIG. 5, the computer 230 generates at least one command to an inline measurement apparatus 215 for in-line analytics, namely, to analyze nano-capsules in each formulation, resulting in measurements of physical properties of the nano-capsules (e.g., particle size, concentration, etc.). The computer 230 can generate commands, etc. similar to the computer 130 of FIG. 1, e.g., for controlling the mixer and sample collector.

During operation, the solutions, e.g., aqueous and organic streams and optionally a buffered saline solution or the like, mixed by the mixer 210 and the resulting mixture collected by the sample collector 220 can be optionally provided to another analysis system such as a DLS plate reader (not shown), which can select wells of a plate of interest from the sample collector 220 and determine one or more properties of a plateful of candidates and formulations. Particle properties, for example, size measurements taken by the particle analyzer 215, can be periodically measured by the DLS plate reader.

FIG. 3 depicts a flowchart of a method 300, in accordance with an embodiment. In describing the method 300, reference is made to components of a system of FIGS. 1-3. In some embodiments, the steps in the method 300 are performed by the special-purpose computer 130 of FIG. 1 or 230 of FIG. 2.

At block 310, at least two solutions are mixed together by a microfluidic mixing apparatus. For example, LNPs encapsulating RNA (LNP-RNA) can be formed by mixing a payload and lipid packets comprised of cationic and neutral lipids in respective solutions, one of the solutions may include lipids in an organic solvent and the other solution may include RNA in an aqueous solvent.

At block 320, measurements of physical properties of the particles, e.g., size, polydispersity and/or concentration of LNP-RNA particles of the formulations formed by the mixing step in block 310 are determined, for example, by an inline measurement apparatus such as a particle analyzer, e.g., an ultraDAWN™ particle analyzer or DynaPro™ ZetaStar™ light scattering instrument by Wyatt Technology, but not limited thereto. This provides immediate feedback to a user, e.g., via a computer display or other visual, audio, and/or tactile communication device, regarding the formation of nanoparticles based on the conditions provided by the computer.

At block 330, each sample is collected by the sample collector from the particle analyzer and in doing so is output to a collection vial or well in a well plate or other vessel. The sample collector is constructed and arranged to accommodate a wide range of adapter racks and related collection vessels. In some embodiments, the samples that are output of the sample collector can be tested, e.g., periodically remeasured, following a ripening period by a light scattering instrument, autosampler, plate reader, or other instrument for remeasuring particle size, concentration, and so on.

FIG. 4 depicts a flowchart of a method 400, in accordance with an embodiment. In describing the method 400, reference is made to components of a system of FIG. 1 or 2. The steps in the method 400 may be performed without human intervention, i.e., using only the system components and in some embodiments, including a robotic apparatus.

At block 410, a special-purpose computer generates and outputs at least one command to a microfluidic mixing apparatus to mix at least two solutions. The command may correspond to a series of mixing parameters and the mixer may perform a mixing operation according to the parameters. In some embodiments, one of the solutions includes encapsulating molecules in an organic solvent and the other solution includes payload molecules in an aqueous solvent, resulting in formulations of nano-capsules encapsulating the payload molecules, e.g., RNA. For example, the computer can instruct the mixing apparatus to form nanoparticles, e.g., LNPs encapsulating RNA (LNP-RNA), by mixing a payload and lipid packets comprised of cationic and neutral lipids in respective solutions.

At block 420, the special-purpose computer generates and outputs at least one command to a sample collection apparatus, for example, a fraction collector, to direct the series of formulations to the fraction collector such that each formulation is dispensed to a distinct receptacle, e.g., a vial or well in a well plate, corresponding to the corresponding mixing parameters, e.g., translate a receptacle to receive dispensed fluid from the mixer.

At block 430, the special-purpose computer generates and outputs at least one command to a particle analyzer to analyze LNP-RNA particles, nano-capsules, or the like in each formulation. The particle analyzer can be an ultraDAWN™ particle analyzer or DynaPro™ ZetaStar™ light scattering instrument by Wyatt Technology, but not limited thereto.

In some embodiments, in response to the computer commands, the instrument, e.g., light scattering instrument, autosampler, plate reader, or other instrument for remeasuring particle size, concentration, and so on, performs measurements of physical properties of the LNP-RNA particles or nano-capsules, such as particle size, concentration, and so on.

At block 450, measurements corresponding to mixing parameters are displayed, for example, at a computer display or other I/O device of the computer system 130 of FIG. 1.

FIG. 6 depicts an example of a system 600 configured for condition screening with inline dilution, in accordance with an embodiment. The system 600 may allow for the screening of different buffer conditions so that a sample can have a desired state, while providing for inline dilution to enhance nanoparticle stability.

In some embodiments, the system 600 includes microfluidic mixing system 610. The microfluidic mixing system 610 may include microfluidic mixers selected from the group consisting of microfluidic mixing chips, T-junction mixers, Y-junction mixers, and augmented T-junction mixers. In some embodiments, the microfluidic mixing system 610 includes a first microfluidic chip 611 serially connected to a second microfluidic chip 612 in series. A first pump 613 and a second pump 614 are coupled via tubing or other flow path to the inlets of the first microfluidic chip 611. The outlet of the first microfluidic chip 611 and a third pump 614 are coupled to the inlets of the second microfluidic chip 612. In some embodiments, the first pump 613, second pump 614, and/or third pump 615 are syringe pumps. In some embodiments, one or more of the first through third pumps 615 can be continuous pumps selected from the group consisting of peristaltic pumps, pressure-driven pumps, piston pumps, and diaphragm pumps. The first pump 613 can provide a lipid solution to the first inlet of the first microfluidic chip 611 and the second pump 614 can provide an RNA solution to the second inlet of the first microfluidic chip 611, which can produce a formulation of lipid nanoparticles (LNPs) encapsulating the RNA that is output to the first inlet of the second microfluidic chip 612. In some experiments, the total flow rate (mL/min) of the first and second pumps 613, 614 may be 4, 6, 8, 10, 12, 14, or 16 mL/min, but not limited thereto. The flow rate ratio of the first pump flow rate to second pump flow rate may be 1:3, 1:4, 1:5, or 1:6 but not limited thereto. The volume of each solution may be 0.5 mL, but not limited thereto. The system 600 can produce 16 conditions per run, but not limited thereto.

The third pump 615 can provide a source of PBS or the like to the second inlet of the second microfluidic chip 612 to provide an inline buffer dilution, which can be performed for stability enhancement or the like.

The second microfluidic chip 612 outputs a mixture of the outputs of the first through third pumps 613-615 to a measurement apparatus 620, for example, similar to or the same as the light scattering instrument 215 of FIG. 2.

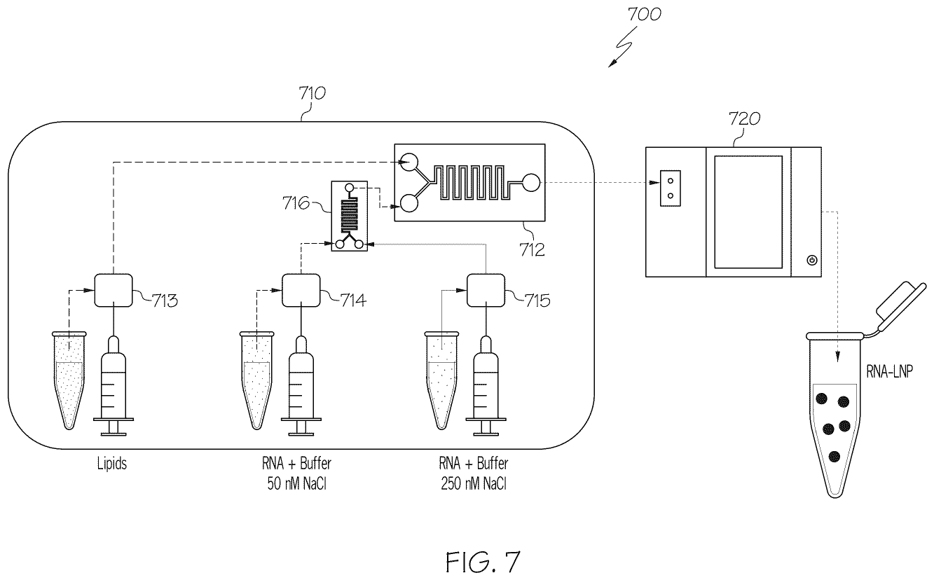

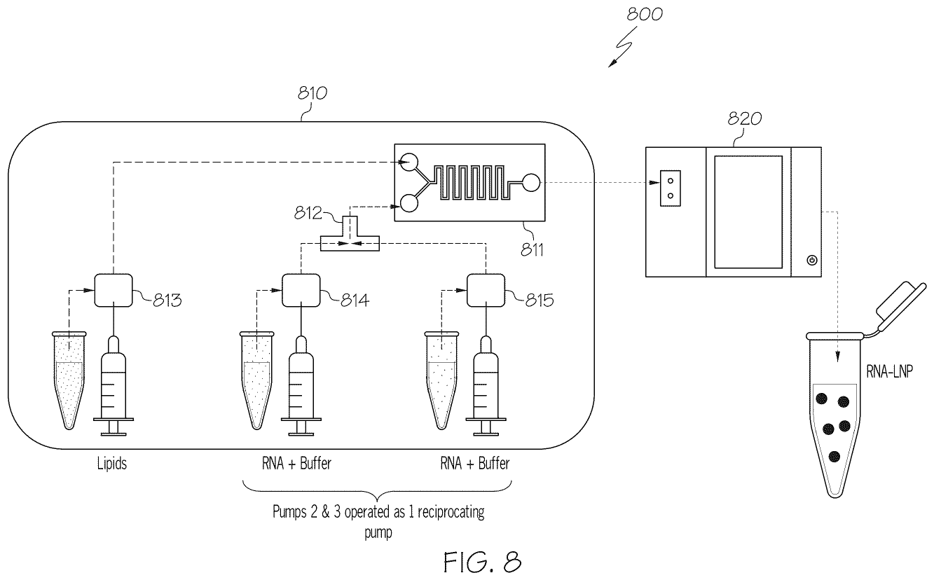

FIG. 7 depicts an example of a system 700 configured for condition screening with buffer variation, in accordance with an embodiment. The system 700 includes a microfluidic mixing system 710, which in some embodiments includes a first microfluidic mixer 712, receiving solutions from a first pump 713 and an output of a second microfluidic mixer 716, which in turn have two inlets for receiving solutions from a second pump 714 and a third pump 715, respectively. In some embodiments, the first pump 713, second pump 714, and/or third pump 715 are syringe pumps. The first pump 713 can provide a lipid solution to the first inlet of the first mixer 712. The second pump 714 can provide a first RNA solution to the first inlet of the second mixer 716. In some embodiments, the first RNA solution includes a first buffer, for example, 50 mM NaCl. The third pump 715 can provide a second RNA solution to the second inlet of the second mixer 716. In some embodiments, the second RNA solution includes a second buffer, for example, 250 mM NaCl. The second mixer 716 can mix the received volumes of RNA solution from the first and second inlets and output the mixed volumes to the second inlet of the first mixer 716.

Accordingly, the microfluidic mixer (or mixing device or mixing chip) 712 can produce a formulation of lipid nanoparticles (LNPs) encapsulating the RNA. In some experiments, the volumes, total flow rate (mL/min), and flow rate ratio are similar to those provided by the system 600 of FIG. 6. In some experiments, the flow rates provided by the second pump 714 and third pump 715 may vary, for example, to achieve 50, 100, 150, 200, or 250 mM NaCl. The volume of each solution may be 0.5 mL, but not limited thereto. The system 700 can produce 120 conditions per run, but not limited thereto.

The mixer 712 outputs a mixture of the outputs of the first through third pumps 713-715 to a measurement apparatus 720, for example, similar to or the same as the light scattering instrument 215 of FIG. 2.

FIG. 8 depicts an example of a system 800 comprising a microfluidic mixing system 810 and Multi-Angle Light Scattering (MALS) detection instrument 820 configured for generating volumes larger than those offered by the configurations of FIGS. 6 and 7, in accordance with an embodiment. The system 800 includes a first pump 813 coupled via tubing or other flow path element to a first inlet of a microfluidic chip 811. The system 800 also includes a three-port union 812. A second pump 814 and third pump 815 are coupled to the two inlets of the union 812. The union outlet is coupled to a second inlet of the microfluidic chip 811. Accordingly, the second pump 814 and third pump 815 can operate as a reciprocating pump such that while pump 814 dispenses at a dispense flow rate, pump 814 fills at a fill flow rate that is equal to or faster than the dispense rate, and when pump 814 has emptied the operation reverses: pump 815 dispenses at the dispense flow rate and pump 814 fills at the fill flow rate, and this alternating (reciprocating) operation continues as many times as necessary. In other words, some embodiments may include at least three pumps that are configured and instructed to deliver solutions to a microfluidic mixer such that a first pump of the at least three pumps delivers the solution with encapsulating molecules, wherein second and third pumps of the at least three pumps deliver a solution containing payload molecules, and the apparatus is controlled to operate the second and third pumps as a reciprocating pump such that while one of the second and third pumps dispenses the other of the second and third pumps loads, then the second and third pumps switch so that while the other of the second and the third pumps dispenses the one of the second and third pumps loads in order to increase a quantity of nano capsules produced before the first pump runs out of encapsulating molecule solution. In some embodiments, the first pump 613, second pump 614, and/or third pump 615 are syringe pumps. The first pump 813 can provide a lipid solution to the first inlet of the microfluidic chip 811. The second pump 814 can provide a first RNA and buffer solution to the first inlet of the union 812 and the third pump 814 can provide a second RNA and buffer solution to the second inlet of the union 812. In some experiments, the total flow rate 10 mL/min, the flow rate ratio is 1:4, the volume: 10 mL, and 10 repeats can be performed for a total of 100 mL at 1 condition per run, but not limited thereto.

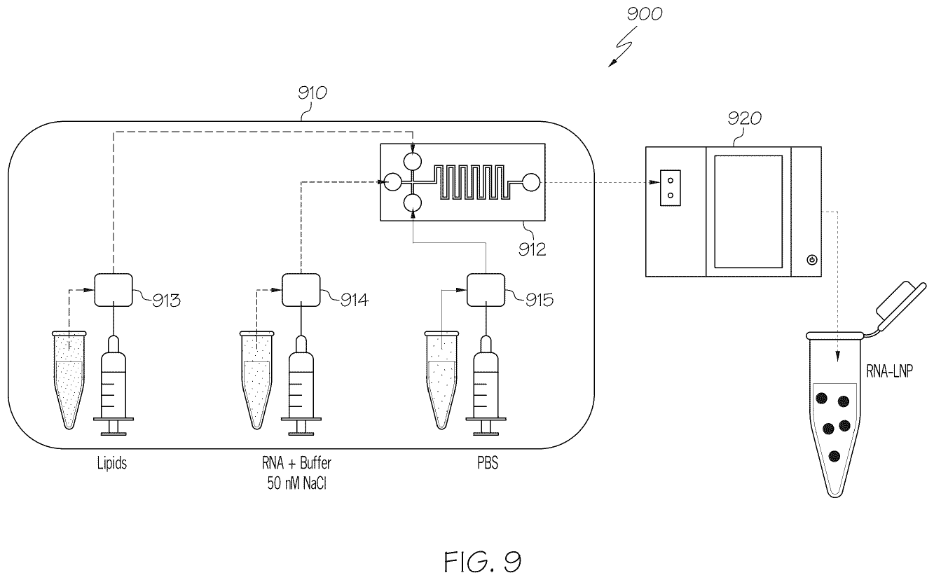

FIG. 9 depicts an example of a system 900 configured for condition screening of small volumes, in accordance with an embodiment. The system 900 includes a three-inlet mixer 912, including three inlets for receiving solutions from a first pump 913, a second pump 914, and a third pump 915, respectively. In some embodiments, the first pump 913, second pump 914, and/or third pump 915 are syringe pumps. The first pump 913 can provide a lipid solution to the first inlet of the mixer 912. The second pump 914 can provide an RNA and buffer solution to the second inlet of the mixer 912. In some embodiments, the first RNA solution includes a first buffer source, for example, 50 mM NaCl. The third pump 915 can provide a source of PBS or the like to the third inlet of the mixer 912 following the production of nanoparticles by mixing the solutions, supplied by pumps 913 and 914, in the mixer 912.

The mixer 912 can produce a formulation of lipid nanoparticles (LNPs) encapsulating the RNA from the two inputs supplied by pumps 913 and 914. In some experiments, the total flow rate (mL/min) and flow rate ratio are similar to those provided by the system 700 of FIG. 7, but the volume is smaller, for example, 0.05 mL. Upon completing the formulation of nanoparticles, the third pump 915 is used to push a volume of PBS or the like through the outlet tubing and particle analyzer 920 in order for the nanoparticles to reach the sample collector.

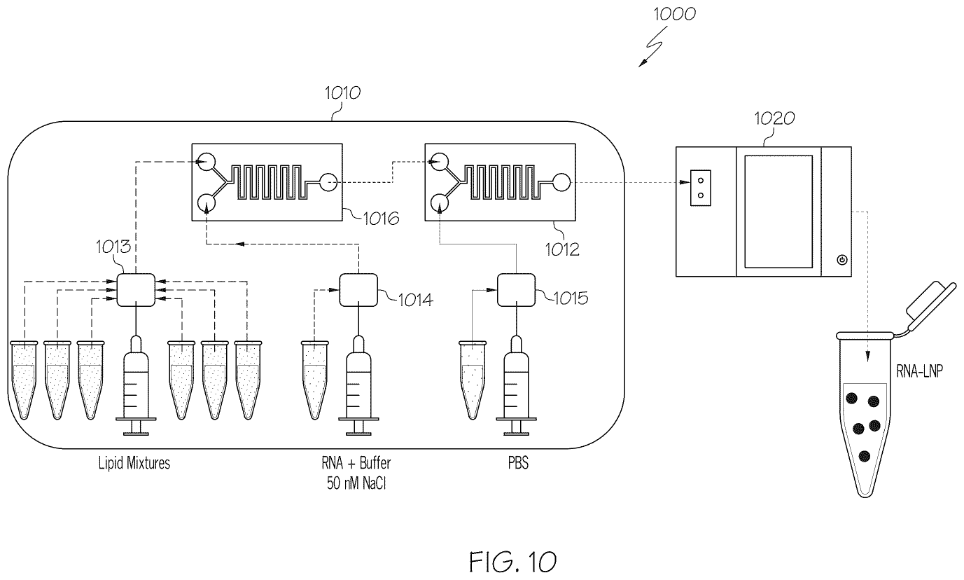

FIG. 10 depicts an example of a system 1000 configured for condition and lipid mixture screening, in accordance with an embodiment. The system 1000 includes a first mixer 1016, receiving solutions from a first pump 1013 and a second pump 1014, and a second mixer receiving the output from mixer 1016 a third pump 1015. In some embodiments, the first pump 1013, second pump 1014, and/or third pump 1015 are syringe pumps. In some embodiments, the first pump 1013 includes a multi-port valve, e.g., an 8-port valve, for providing up to 6 lipid solutions to the first inlet of the mixer 1012. The second pump 1014 can provide an RNA and buffer solution to the second inlet of the mixer 1012. In some embodiments, the first RNA solution includes a first buffer source, for example, 50 mM NaCl. The third pump 1015 can provide a source of PBS or the like to the mixer 1012 to provide an inline buffer dilution, which can enhance stability of the nanoparticle formulation or the like.

The mixer 1012 can produce a formulation of lipid nanoparticles (LNPs) encapsulating the RNA from the three inputs. In some experiments, the volumes, total flow rate (mL/min), and flow rate ratio are similar to those provided by a system of FIGS. 6-9. However, the system 1000 can provide up to 96 different samples per run, or 16 conditions per run for each of 6 lipid mixtures.

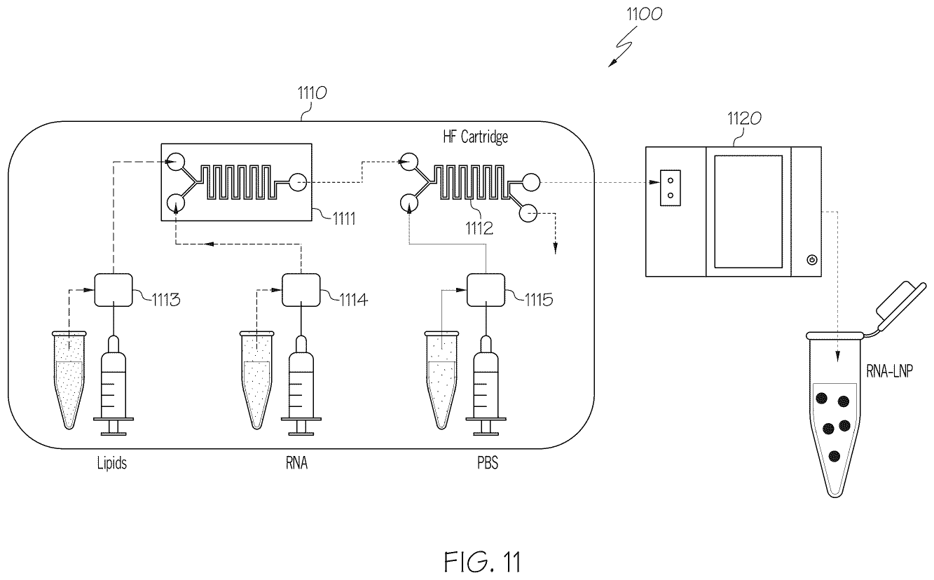

FIG. 11 depicts an example of a system 1100 configured for condition screening with an inline buffer exchange, in accordance with an embodiment. The system 1100 includes a microfluidic mixing chip 1111 serially connected to a hollow-fiber (HF) cartridge 1112 for TFF. A first pump 1113 and a second pump 1114 are coupled via tubing or other flow path to the inlets of the microfluidic chip 1111. The outlet of the first microfluidic chip 1111 and a third pump 1114 are coupled to the inlets of the HF cartridge 1112. In some embodiments, the first pump 1113, second pump 1114, and/or third pump 1115 are syringe pumps. The first pump 1113 can provide a lipid solution to the first inlet of the microfluidic chip 1111 and the second pump 1114 can provide an RNA solution to the second inlet of the microfluidic chip 1111, which can produce a formulation of lipid nanoparticles (LNPs) encapsulating the RNA that is output to the first inlet of the HF cartridge 1112, which may have a second outlet to a waste outlet or the like for removing solvent or the like from the input to the cartridge 1112. The first and second pumps may provide formulation conditions such as total flow rate, e.g., 4, 6, 8, 10 mL/min, etc. and the third pump provides for a buffer exchange, for example, a flow rate of 80% (which is equal to 4 times the combined flow rates of the first and second pumps. In some experiments, the volumes, total flow rate (mL/min), and flow rate ratio are similar to those provided by a system of FIGS. 6-10. However, the third pump 1115 can provide a source of PBS or the like to the second inlet of the second microfluidic chip 612 to provide an inline buffer exchange and dilution for enhancing formulation stability, where the third pump flow rate equals four (4) times the combined first and second pump flow rates.

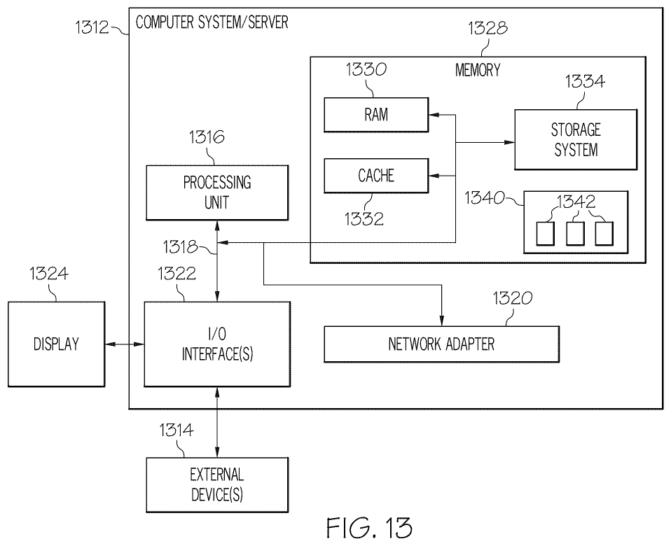

FIG. 13 depicts a computer system 1300 in accordance with an exemplary embodiment. In an exemplary embodiment, the computer system 1300 is a standalone computer system, a network of distributed computers, or a cloud computing node server. In some embodiments, the computer system 1300 can perform some or all of the method 400 of FIG. 4 and/or method 500 of FIG. 5. Computer system 1300 is only one example of a computer system and is not intended to suggest any limitation as to the scope of use or functionality of embodiments of the present disclosure. Regardless, computer system 1300 is capable of being implemented to perform and/or performing any of the functionality/operations of the present disclosure.

Computer system 1300 includes a computer system/server 1312, which is operational with numerous other general purpose or special purpose computing system environments or configurations. Examples of well-known computing systems, environments, and/or configurations that may be suitable for use with computer system/server 1312 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 1312 may be described in the general context of computer system-executable instructions, such as program modules, being executed by a computer system. Generally, program modules may include routines, programs, objects, components, logic, and/or data structures that perform particular tasks or implement particular abstract data types. Computer system/server 1312 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 13, the components of computer system/server 1312 may include, but are not limited to, one or more processors or processing units 1316, a system memory 1328, and a bus 1318 that couples various system components including system memory 1328 to processor 1316. The computer system 130 of FIG. 1 may include some or all of the components described with reference to the computer system 1300.

Bus 1318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 1312 typically includes a variety of computer system readable media. Such media may be any available media that is accessible by computer system/server 1312, and includes both volatile and non-volatile media, removable and non-removable media.

System memory 1328 can include computer system readable media in the form of volatile memory, such as random access memory (RAM) 1330 and/or cache memory 1332.

Computer system/server 1312 may further include other removable/non-removable, volatile/non-volatile computer system storage media. By way of example only, storage system 1334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1318 by one or more data media interfaces. As will be further depicted and described below, memory 1328 may include at least one program product having a set (e.g., at least one) of program modules that are configured to carry out the functions/operations of embodiments of the disclosure.

Program/utility 1340, having a set (at least one) of program modules 1342, may be stored in memory 1328 by way of example, and not limitation. Exemplary program modules 1342 may include an operating system, one or more application programs, other program modules, and program data. Each of the operating system, one or more application programs, other program modules, and program data or some combination thereof, may include an implementation of a networking environment. Program modules 1342 generally carry out the functions and/or methodologies of embodiments of the present disclosure.

Computer system/server 1312 may also communicate with one or more external devices 1314 such as a keyboard, a pointing device, a display 1324, one or more devices that enable a user to interact with computer system/server 1312, and/or any devices (e.g., network card, modem, etc.) that enable computer system/server 1312 to communicate with one or more other computing devices. Such communication can occur via Input/Output (I/O) interfaces 1322. Still yet, computer system/server 1312 can communicate with one or more networks such as a local area network (LAN), a general wide area network (WAN), and/or a public network (e.g., the Internet) via network adapter 1320. As depicted, network adapter 1320 communicates with the other components of computer system/server 1312 via bus 1318. It should be understood that although not shown, other hardware and/or software components could be used in conjunction with computer system/server 1312. Examples include, but are not limited to microcode, device drivers, redundant processing units, external disk drive arrays, RAID systems, tape drives, and data archival storage systems.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer system, a series of mixing parameters;
transmitting, by the computer system, a series of commands corresponding to the series of mixing parameters to a microfluidic mixing system to mix a series of at least two solutions, wherein one of the solutions includes lipids in an organic solvent and the other of the solutions includes ribonucleic acid (RNA) in an aqueous solvent; and
generating in response a plurality of formulations of lipid nanoparticles (LNPs) encapsulating the RNA, LNP-RNA particles, according to the series of mixing parameters.

2. The computer-implemented method of claim 1, further comprising:
transmitting, by the computer system, a command to direct the plurality of formulations to a sample collector such that each of the formulations is dispensed to a distinct receptacle corresponding to corresponding mixing parameters.

3. The computer-implemented method of claim 1, further comprising:
transmitting, by the computer system, a command to a particle analyzer for performing inline analytics to analyze LNP-RNA particles in each of the formulations, resulting in measurements of physical properties of the LNP-RNA particles.

4. The computer-implemented method of claim 3, further comprising:
storing, by the computer system, the measurements in a database corresponding to the mixing parameters.

5. The computer-implemented method of claim 3, further comprising:
displaying, by the computer system, on a display the measurements corresponding to the mixing parameters.

6. The computer-implemented method of claim 3, wherein the particle analyzer is selected from the group consisting of a Multi-Angle Light Scattering (MALS) detection instrument, a dynamic light scattering (DLS) instrument, and an electrophoretic light scattering (ELS) instrument.

7. The computer-implemented method of claim 1, wherein the transmitting comprises
transmitting, by the computer system, the series of commands corresponding to the series of mixing parameters to a microfluidic mixer to mix a series of at least two solutions, wherein one of the solutions includes encapsulating molecules in an organic solvent and the other of the solutions includes payload molecules in an aqueous solvent.

8. A computer-implemented method, comprising:
receiving, by a computer system, a series of mixing parameters;
transmitting, by the computer system, a series of commands corresponding to the series of mixing parameters to a microfluidic mixer to mix a series of at least two solutions, wherein one of the solutions includes encapsulating molecules in an organic solvent and the other of the solutions includes payload molecules in an aqueous solvent, resulting in formulations of nano-capsules encapsulating the payload molecules according to the series of mixing parameters; and
transmitting, by the computer system, a command to direct the formulations to a sample collector such that each of the formulations is dispensed to a distinct receptacle corresponding to corresponding mixing parameters.

9. The computer-implemented method of claim 8, further comprising
transmitting, by the computer system, a command to a particle analyzer to analyze nano-capsules in each of the formulations, resulting in measurements of physical properties of the nano-capsules.

10. The computer-implemented method of claim 9, further comprising:
storing, by the computer system, the measurements in a database corresponding to the mixing parameters.

11. The computer-implemented method of claim 9, further comprising:
displaying, by the computer system, on a display the measurements corresponding to the mixing parameters.

12. An apparatus comprising:
a microfluidic mixer that mixes a series of at least two solutions, wherein one of the solutions includes encapsulating molecules in an organic solvent and the other of the solutions includes payload molecules in an aqueous solvent, resulting in formulations; and
a sample collector to dispense each of the formulations to a distinct receptacle corresponding to corresponding mixing parameters and to translate a receptacle to receive dispensed fluid from the mixer.

13. The apparatus of claim 12 further comprising:
a flow-through particle analyzer to analyze lipid nanoparticles (LNPs) encapsulating ribonucleic acid (RNA), LNP-RNA particles, in each of the formulations, resulting in measurements of physical properties of the LNP-RNA particles.

14. The apparatus of claim 12, further comprising at least three pumps, wherein the microfluidic mixer includes a first microfluidic mixer and a second microfluidic mixer and two of the at least three pumps are configured and instructed to deliver the encapsulating molecules including lipids and the payload molecules, respectively, to the first microfluidic mixer in order to produce nanocapsules, and wherein the nanocapsules are further combined in the second microfluidic mixer with a diluent (PBS) delivered by a third pump of the at least three pumps in order to stabilize the nanocapsules.

15. The apparatus of claim 12, further comprising at least three pumps, wherein the microfluidic mixer includes a first microfluidic mixer and a second microfluidic mixer and two of the at least three pumps are configured and instructed to deliver the encapsulating molecules including lipids and the payload molecules, respectively, to the first microfluidic mixer in order to produce nanocapsules, and wherein the nanocapsules are further combined in a hollow fiber cartridge with a diluent delivered by a third pump of the at least three pumps in order to remove organic solvent and thus stabilize the nanocapsules.

16. The apparatus of claim 12, further comprising at least three pumps, wherein the at least three pumps are configured and instructed to deliver solutions to the microfluidic mixer such that a first pump of the at least three pumps delivers the solution with encapsulating molecules including lipids, a second pump of the at least three pumps delivers a solution containing payload molecules in a first aqueous buffer and the third pump delivers a solution containing the payload molecules in a second aqueous buffer, and the apparatus is controlled to vary the ratio between the second pump and the third pump in order to test the effect of varying aqueous buffers on final nanocapsules.

17. The apparatus of claim 12, further comprising at least three pumps, wherein the at least three pumps are configured and instructed to deliver solutions to the microfluidic mixer such that a first pump of the at least three pumps delivers the solution with encapsulating molecules, wherein second and third pumps of the at least three pumps deliver a solution containing payload molecules, and the apparatus is controlled to operate the second and third pumps as a reciprocating pump such that while one of the second and third pumps dispenses, the other of the second and third pumps loads, then the second and third pumps switch so that while the other of the second and the third pumps dispenses, the one of the second and third pumps loads in order to increase a quantity of nanocapsules produced before the first pump runs out of an encapsulating molecule solution.

18. The apparatus of claim 12, further comprising at least three pumps, wherein first and second pumps of the at least three pumps are configured and instructed to deliver the encapsulating molecules and the payload molecules, respectively, to the microfluidic mixer in order to produce a small quantity of nanocapsules, such that the nanocapsules are initially contained within a volume of capillary tubing, and the nanocapsules are pushed out of the system to a sample collector with an aqueous solution delivered by a third pump of the at least three pumps.

19. The apparatus of claim 12, further comprising a pump configured with a solution selection valve that can be controlled to draw from any of a set of solutions of encapsulating molecules wherein the set of solutions comprises different compositions of encapsulating molecules in an organic solvent.

20. The apparatus of claim 12, wherein the microfluidic mixing device comprises more than three pumps.
